(19) United States
(12) Patent Application Publication
(10) Pub. No.: US 2022/0305934 A1
(43) Pub. Date: Sep. 29, 2022

(54) CHARGING STATION MONITORING METHOD AND DEVICE

(71) Applicant: LIIKENNEVIRTA OY / VIRTA LTD, Helsinki (FI)

(72) Inventor: Jussi AHTIKARI, Helsinki (FI)

(73) Assignee: LIIKENNEVIRTA OY / VIRTA LTD, Helsinki (FI)

(21) Appl. No.: 17/635,423

(22) PCT Filed: Jul. 29, 2020
(86) PCT No.: PCT/FI2020/050508

§ 371 Date: Feb. 15, 2022

(30) Foreign Application Priority Data
Aug. 15, 2019 (FI) 20195682

(51) Int. Cl. B60L 53/60; G06K 9/62; G06N 20/00

(52) U.S. Cl. CPC B60L 53/60; G06K 9/6256; G06K 9/6262; G06N 20/00; G06K 9/6232; B60L 2260/46

(57) ABSTRACT

It is an object to provide an electric vehicle charging station monitoring device and method. According to an embodiment, a method comprises: obtaining a training data set from an electric vehicle, EV, charging network comprising; training a machine learning model with the training data set; obtaining an input data set from the EV charging network; inputting the input data set into the trained machine learning model; obtaining an output data set from the trained machine learning model; and identifying a malfunction of at least one EV charging station based on the output data set. A device, a method, and a computer program product are provided.

### TECHNICAL FIELD

The present disclosure relates to electric vehicle charging, and more particularly to an electric vehicle charging station monitoring method and device.

### BACKGROUND

An electric vehicle (EV) charging network may comprise various different EV charging stations, such as direct current charging stations and alternating current charging stations, from different manufacturers. The EV charging stations may experience various issues, such as electrical issues, compatibility issues with different vehicles, problems with mobile network connections and so on. Thus, it may be challenging to reliably detect if an EV charging station is malfunctioning in some manner or to obtain information about the cause of the malfunction. Furthermore, prediction of such malfunctions may be difficult.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object to provide a charging station monitoring device and a charging station monitoring method. The foregoing and other objects are achieved by the features of the independent claims. Further implementation forms are apparent from the dependent claims, the description and the figures.

According to a first aspect, a method comprises: obtaining a training data set from an electric vehicle, EV, charging network comprising a plurality of EV charging stations; training a machine learning model with the training data set; obtaining an input data set from the EV charging network; inputting the input data set into the trained machine learning model; obtaining an output data set from the trained machine learning model; and identifying a malfunction of at least one EV charging station in the plurality of EV charging stations based on the output data set. The method may enable, for example, detecting a charging station that is malfunctioning and/or predicting a malfunction of a charging station before the malfunction occurs.

In an implementation form of the first aspect, the method further comprises: obtaining a validation data set from the EV charging network; and validating the trained machine learning model using the validation data set. The method may enable, for example, identifying a malfunction more reliably.

In a further implementation form of the first aspect, the training data set, the validation data set, and/or the input data set further comprises additional information from at least one resource outside the EV charging network. The method may enable, for example, using information from outside the charging network in order to take into account other factors that may affect operation of the charging network.

In a further implementation form of the first aspect, the output data set comprises at least one of: indication of a subset of the plurality of EV charging stations; or indication of at least one charging event. The method may enable, for example, indicating charging stations that are malfunctioning and/or are probable to malfunction.

In a further implementation form of the first aspect, the training data set and/or the input data set comprises at least one of: a usage history of at least one EV charging station in the plurality of EV charging stations; a location of at least one EV charging station in the plurality of EV charging stations; a type of at least one EV charging station in the plurality of EV charging stations; an error history of at least one EV charging station in the plurality of EV charging stations; a weather information at a location of at least one EV charging station in the plurality of EV charging stations; or an external resource information related to a location of at least one EV charging station in the plurality of EV charging stations. The method may enable, for example, using information from the charging network in order to take into account factors that may affect operation of the charging network.

In a further implementation form of the first aspect, the machine learning model comprises at least one of: linear regression; decision forest regression; boosted decision tree regression; fast forest quantile regression; neural network; or Poisson regression. The method may enable, for example, detecting a charging station that is malfunctioning and/or predicting a malfunction of a charging station with high accuracy and/or efficiency.

In a further implementation form of the first aspect, the method further comprises at least one of, before the training the machine learning model with the training data set: performing feature extraction on the training data set; performing feature transformation on the training data set; or performing feature scaling on the training data set. The method may enable, for example, pre-processing the training data set in such a manner that the machine learning model can be trained efficiently.

It is to be understood that the implementation forms of the first aspect described above may be used in combination with each other. Several of the implementation forms may be combined together to form a further implementation form.

According to a second aspect, a computer program product is provided, comprising program code configured to perform a method according to the first aspect when the computer program is executed on a computer.

According to a third aspect, a computing device is configured to: obtain a training data set from an electric vehicle, EV, charging network comprising a plurality of EV charging stations; train a machine learning model with the training data set; obtain an input data set from the EV charging network; input the input data set into the trained machine learning model; obtain an output data set from the trained machine learning model; and identify a malfunction of at least one EV charging station in the plurality of EV charging stations based on the output data set.

In an implementation form of the third aspect, the computing device is further configured to: obtain a validation data set from the EV charging network; and validate the trained machine learning model using the validation data set.

In a further implementation form of the third aspect, the training data set, the validation data set, and/or the input data set further comprises additional information from at least one resource outside the EV charging network.

In a further implementation form of the third aspect, the output data set comprises at least one of: indication of a subset of the plurality of EV charging stations; or indication of at least one charging event.

In a further implementation form of the third aspect, the training data set and/or the input data set comprises at least one of: a usage history of at least one EV charging station in the plurality of EV charging stations; a location of at least one EV charging station in the plurality of EV charging stations; a type of at least one EV charging station in the plurality of EV charging stations; an error history of at least one EV charging station in the plurality of EV charging stations; a weather information at a location of at least one EV charging station in the plurality of EV charging stations; or an external resource information related to a location of at least one EV charging station in the plurality of EV charging stations.

In a further implementation form of the third aspect, the machine learning model comprises at least one of: linear regression; decision forest regression; boosted decision tree regression; fast forest quantile regression; neural network; or Poisson regression.

In a further implementation form of the third aspect, the computing device is further configured to perform at least one of, before training the machine learning model with the training data set: perform feature extraction on the training data set; perform feature transformation on the training data set; or perform feature scaling on the training data set.

It is to be understood that the implementation forms of the third aspect described above may be used in combination with each other. Several of the implementation forms may be combined together to form a further implementation form.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 illustrates a flow chart representation of a method for charging station monitoring according to an embodiment;

FIG. 2 illustrates a schematic representation of a computing device for charging station monitoring according to an embodiment;

FIG. 3 illustrates a schematic representation of machine learning model training according to an embodiment;

FIG. 4 illustrates a block diagram representation of a system for charging station monitoring according to an embodiment; and

FIG. 5 illustrates a flow chart representation of a method for charging station monitoring according to an embodiment.

In the following, like reference numerals are used to designate like parts in the accompanying drawings.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilized and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

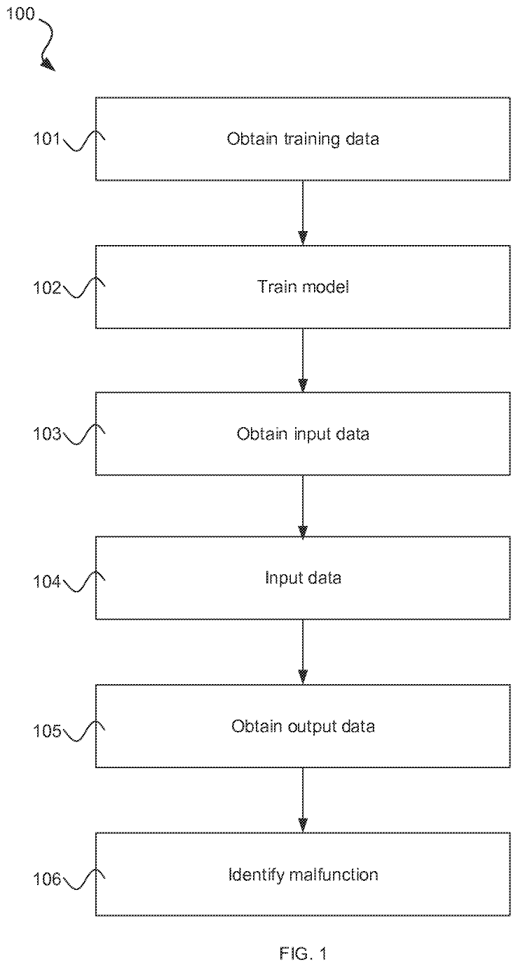

FIG. 1 illustrates a flow chart representation of a method 100 for charging station monitoring according to an embodiment.

According to an embodiment, the method 100 comprises obtaining 101 a training data set from an electric vehicle (EV) charging network comprising a plurality of EV charging stations. The obtaining may be performed by, for example, a computing device that is coupled to the EV charging network via a telecommunication network/link. Such computing device may, for example, gather the training data by communicating with the plurality of EV charging stations. Each EV charging station may comprise a computing device that may be configured to gather data, such as usage data, about the EV charging station. The training data set may comprise, for example, training input data and training output data.

An EV charging station may refer to a device that may be used to charge an EV, such as an electric car. An EV charging network may refer to a network of EV charging stations. Each EV charging stations in the EV charging network may, for example, be connected to a computing device, such as a server, via a telecommunication network or similar. The EV charging stations in the EV charging network may be, for example, monitored and/or administrated using the computing device.

The method 100 may further comprise training 102 a machine learning model with the training data set. The training 102 may comprise, for example, using a learning algorithm to train the machine learning model. The learning algorithm may comprise, for example, supervised learning, unsupervised learning, reinforcement learning, feature learning, sparse dictionary learning, anomaly detection, and/or association rules.

The training data may comprise, for example, a training input data set and a training output data set. The training 102 may comprise adjusting parameters of the machine learning model so that the machine learning model produces an output that matches the training output data set for a corresponding training input data set. The training input data set may comprise, for example, data related to the operation of the EV charging stations, and the training output data set may comprise data indicating malfunctioned EV charging stations.

In some embodiments, other operations, such as feature extraction, feature transformation and/or feature scaling/normalisation may be performed on the training data set before training 102 the machine learning model with the training data set.

The method 100 may further comprise obtaining 103 an input data set from the EV charging network. The input data set may be obtained continuously during the operation of the EV charging stations.

The method 100 may further comprise inputting 104 the input data set into the trained machine learning model. In some embodiments, other operations, such as feature extraction, feature transformation and/or feature scaling/normalisation may be performed on the input data set before inputting the input data set into the trained machine learning model.

The method 100 may further comprise obtaining 105 an output data set from the trained machine learning model. The output data set may comprise, for example, a list of EV charging stations with malfunctions and/or EV charging stations that are predicted to malfunction. The EV charging stations that are predicted to malfunction may be indicated using, for example, a numerical value. For example, the numerical value may indicate the probability that the EV charging station is going to malfunction in a predetermined time interval.

The method 100 may further comprise identifying 106 a malfunction of at least one EV charging station in the plurality of EV charging stations based on the output data set. The identifying may comprise, for example, predicting a malfunction of at least one EV charging station before the EV charging station malfunction and/or identifying a malfunction of at least one EV charging station that is occurring currently. The malfunction may be of such type that the malfunction may be difficult to detect/identify using other schemes.

According to an embodiment, the method 100 further comprises obtaining a validation data set from the electric vehicle charging network; and validating the trained machine learning model using the validation data set. The validation data set may comprise a validation input data set and a validation output data set. The validation may comprise comparing results provided by the machine learning model for the validation input data set to the validation output data set. The training data set may comprise data for EV charging stations not included in training data set. The machine learning model and parameters of the machine learning model can be refined in order to obtain improved results from the machine learning model.

FIG. 2 illustrates a schematic representation of the computing device 200 according to an embodiment.

The computing device 200 may comprise at least one processor 201. The at least one processor 201 may comprise, for example, one or more of various processing devices, such as a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The computing device 200 may further comprise a memory 202. The memory 202 may be configured to store, for example, computer programs and the like. The memory 202 may comprise one or more volatile memory devices, one or more non-volatile memory devices, and/or a combination of one or more volatile memory devices and nonvolatile memory devices. For example, the memory 202 may be embodied as magnetic storage devices (such as hard disk drives, floppy disks, magnetic tapes, etc.), optical magnetic storage devices, and semiconductor memories (such as mask ROM, PROM (programmable ROM), EPROM (erasable PROM), flash ROM, RAM (random access memory), etc.).

When the computing device 200 is configured to implement some functionality, some component and/or components of the computing device 200, such as the at least one processor 201 and/or the memory 202, may be configured to implement this functionality. Furthermore, when the at least one processor 201 is configured to implement some functionality, this functionality may be implemented using program code comprised, for example, in the memory 202. For example, if the computing device 200 is configured to perform an operation, the at least one memory 202 and the computer program code can be configured to, with the at least one processor 201, cause the computing device 200 to perform that operation.

According to an embodiment, the computing device 200 is configured to: obtain a training data set from an EV charging network comprising a plurality of EV charging stations.

The computing device 200 may be further configured to train a machine learning model with the training data set.

The computing device 200 may be further configured to obtain an input data set from the EV charging network.

The computing device 200 may be further configured to input the input data set into the trained machine learning model.

The computing device 200 may be further configured to obtain an output data set from the trained machine learning model.

The computing device 200 may be further configured to identify a malfunction of at least one EV charging station in the plurality of EV charging stations based on the output data set.

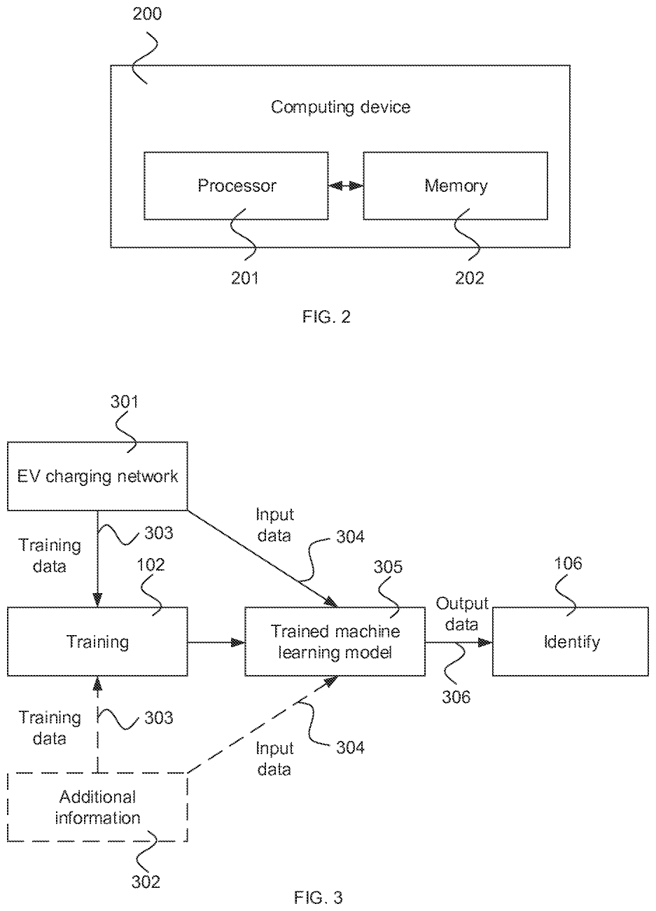

FIG. 3 illustrates a schematic representation of machine learning model training according to an embodiment.

A machine learning model can be trained using a training data set 303, producing a trained machine learning model 305. An input data set 304 can be fed into the trained machine learning model 305, and the trained machine learning model 305 can output an output data set 306. Based on the output data set 306, a malfunction of at least one EV charging station in the plurality of EV charging stations can be identified.

According to an embodiment, the training data set 303, the validation data set, and/or the input data set 304 further comprises additional information 302 from at least one resource outside the electric vehicle charging network. A resource outside the EV charging network may be referred to as an external resource.

The training data set 303 may be obtained from the EV charging network 301. Additionally, the training data set 303 may comprise additional information 302. The additional information 302 may be obtained from outside the EV charging network 301.

The input data set 304 may be obtained from the EV charging network 301. Additionally, the input data set 304 may comprise additional information 302. The additional information 302 may be obtained from outside the EV charging network 301.

The additional information 302 in the training data set 303 and/or in the input data set 304 may be obtained from, for example, external resources. The additional information 302 may comprise data that is not directly obtained from the EV charging network 301. Such data may comprise, for example, weather data and/or geographical data. The additional information 302 may be provided, for example, by third parties. For example, a third party may maintain a service for providing weather information, and the computing device 200 may obtain the weather information at the location of an EV charging station by querying such service.

The training data set 303 and/or the input data set 304 may comprise, for example, the EV charging stations and their usage history, additional point of interest (POI) data, and/or messages, such as error messages, the EV charging station has sent and received.

In response to inputting the input data set 304 into the trained machine learning model 305, the trained machine learning model 305 may output an output data set 306. The output data set 306 may comprise, for example, a list of malfunctioning EV charging stations, a list of EV charging stations that are likely to malfunction in the near future, and/or a list of individual charging events that are considered abnormal. For example, the charging current and/or duration of a charging event may be unusual compared to other charging events in the EV charging network 301. According to an embodiment, the output data set may comprise a predictor model for predicting charge speed by above parameters.

Based on the output data set 306, a malfunction of at least one EV charging station in the plurality of EV charging stations can be identified.

According to an embodiment, the output data set 306 comprises at least one of: indication of a subset of the plurality of EV charging stations; or indication of at least one charging event. The indication of a subset of the plurality of EV charging stations may correspond to, for example, EV charging stations that are malfunction or are likely to malfunction. The subset may comprise one or more EV charging stations. The indication of the subset may comprise, for example, a list of identifications of the EV charging stations in the subset. The indication of at least one charging event may correspond to at least one abnormal charging event.

According to an embodiment, the training data set 303 and/or the input data set 304 comprises a usage history of at least one EV charging station in the plurality of EV charging stations. The usage history may comprise, for example, time information of charging events, users of the EV charging station, length of charging events, energy usage of the EV charging station over time, EV models of users, battery capacity of EVs of users etc.

Alternatively or additionally, the training data set 303 and/or the input data set 304 may comprise a location of at least one EV charging station in the plurality of EV charging stations. The location may comprise, for example, global positioning system (GPS) coordinates, country, city, district of an EV charging station etc.

Alternatively or additionally, the training data set 303 and/or the input data set 304 may comprise a type of at least one EV charging station in the plurality of EV charging stations. The type may comprise, for example, indication whether the EV charging station is a direct current (DC) or an alternating current (AC) charging station, socket types of the EV charging station, maximum charging power of the EV charging station etc.

Alternatively or additionally, the training data set 303 and/or the input data set 304 may comprise an error history of at least one EV charging station in the plurality of EV charging stations. The error history may comprise, for example, error messages or other messages sent by the charging station, any errors detected by the EV charging station etc.

Alternatively or additionally, the training data set 303 and/or the input data set 304 may comprise a weather information at a location of at least one EV charging station in the plurality of EV charging stations. The weather information may comprise, for example, air temperate at or near the EV charging station, minimum/maximum air temperate at or near the EV charging station, rain/snow amount at or near the EV charging station etc.

Alternatively or additionally, the training data set 303 and/or the input data set 304 may comprise an external resource information related to a location of at least one EV charging station in the plurality of EV charging stations. The external resource information may comprise, for example, public point of interest (POI) data, such as restaurants, cafes, gas stations etc. near the station, geographical population data near the EV charging station, geographical electric vehicle data near the EV charging station, such as how many people near the station own electric vehicles etc.

Alternatively or additionally, the training data set 303 and/or the input data set 304 may comprise, for example, an indication of the pricing model of the EV charging station and/or target charge duration/power of the EV charging station.

According to an embodiment, the machine learning model comprises at least one of: linear regression; decision forest regression; boosted decision tree regression; fast forest quantile regression; neural network; or Poisson regression. Linear regression may perform well on, for example, high-dimensional, sparse data sets lacking complexity. Decision trees can be efficient in both computation and memory usage during training and prediction.

According to an embodiment, the method 100 further comprises at least one of, before the training the machine learning model with the training data set: performing feature extraction on the training data set; performing feature transformation on the training data set; or performing feature scaling on the training data set.

According to an embodiment, the method 100 further comprises at least one of, before the inputting the input data set into the trained machine learning model: performing feature extraction on the input data set; performing feature transformation on the input data set; or performing feature scaling on the input data set.

Feature extraction may reduce non-informative and/or redundant data from the training. For example, charge speed and charge power may be strongly connected and can be considered as redundant data.

Feature transformation can change how features are represent to the machine learning model. Feature transformation should preserve data attributes. For example, a day of the week should be presented, integers 1-7 can be used for day. However, using this approach the first day will have different value than the last day of the week. Thus, this is may not be a good transformation. As a solution, seven features each representing a day of week can be used. The value can be 1 if it equals that day, otherwise 0.

Feature scaling/normalization may enable faster training of the machine learning model. Feature scaling/normalization may, for example, limit value ranges for features, since some ML algorithms may require this. Feature scaling/normalization may also be used to represent meaningful information.

After the feature extraction, the feature transformation, and/or the feature scaling, the resulting data set may comprise, for example, a list of normal charging events in the past, a list of not normal charging events in the past, and/or a list of charging station errors in the past. Based on the resulting data set, the machine learning model can be trained, and/or the resulting data set can be fed into the trained machine learning model.

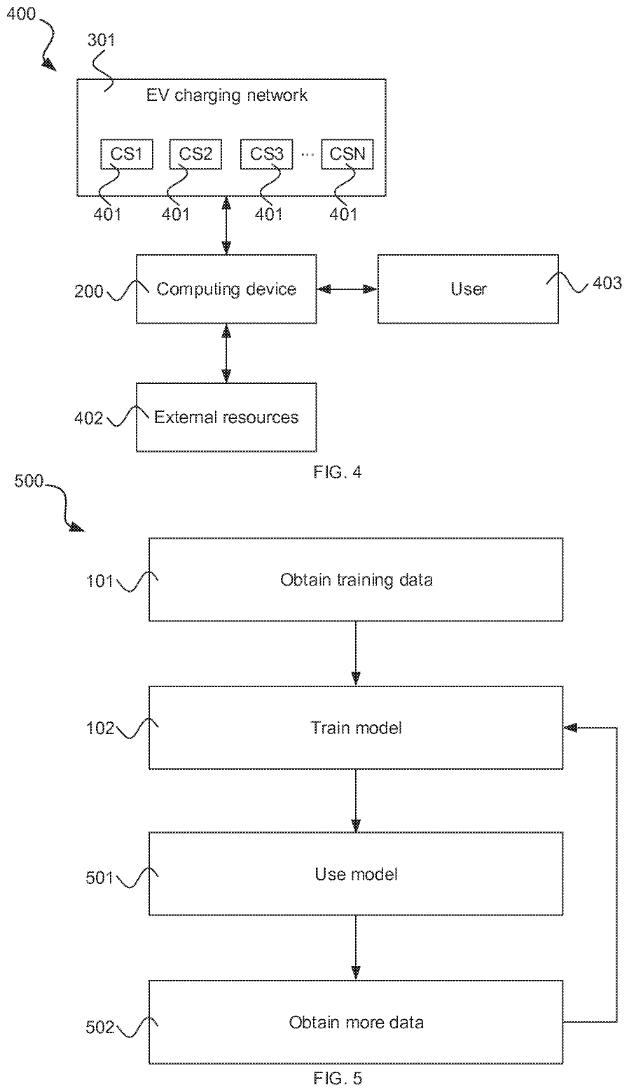

FIG. 4 illustrates a schematic representation of a system 400 for charging station monitoring according to an embodiment.

The system 400 may comprise an EV charging network 301, a computing device 200, external resources 402, and/or a user 403. The EV charging network 301 may comprise a plurality of EV charging stations 401.

The computing device 200 may communicate with the EV charging network 301 and/or the external resources 402 using, for example, data connections. A resource outside the EV charging network 301 may be referred to as an external resource 402. The computing device may be configured to obtain training data, input data, and/or validation data from the EV charging network 301. The computing device 200 may also be configured to obtain additional information 302 from the external resources 402. The training data 303, the input data 304, and/or the validation data may comprise the additional information 302.

The computing device 200 may communicated with the EV charging network 301 and/or with the external resources 402 via, for example, a data connection. The data connection may be any connection that enables the computing device 200 to communicate with the EV charging network 301 and/or the external resources 402. The data connection may comprise, for example, internet, Ethernet, 3G, 4G, long-term evolution (LTE), new radio (NR), Wi-Fi, or any other wired or wireless connections or some combination of these. For example, the data connection may comprise a wireless connection, such as WiFi, an internet connection, and an Ethernet connection.

A user 403 may interact with the computing device. The interaction may be direct via, for example, a user interface, or indirect. The user 403 may be, for example, an administrator of the EV charging network 301. Based on the interaction, the user 403 can perform actions related to the EV charging network 301. For example, if the trained machine learning model 305 running on the computing device 200 identifies a malfunctioning EV charging station 401, the user 403 may perform maintenance or preventative measures on the malfunctioning EV charging station 401.

FIG. 5 illustrates a flow chart representation of a method 500 according to an embodiment.

After the training data has been obtained 101 and the machine learning model has been trained 102 using the training data, the trained machine learning model can be used 501. Using 501 the trained machine learning model may comprise, for example, operations 104-106. Therefore, using 501 the trained machine learning model may refer to inputting input data into the trained machine learning model and obtaining output data from the trained machine learning model.

As the trained machine learning model 305 is used 501, more data can be obtained 502. The trained machine learning model 305 can be trained further using the data obtained while using the trained machine learning model 305 as illustrated in the embodiment of FIG. 5. For example, the input data set 304 and the output data set 306 can be used as a new training data set, and the trained machine learning model 305 can be trained further using the new training data set. This procedure can be repeated as the trained machine learning model 305 is used as is illustrated in the embodiment of FIG. 5.

Once the machine learning model 305 has been trained, it can be used to, for example notice possible errors with EV charging stations 401. Random errors may be especially difficult to detect using other procedures. For example, an EV charging station 401 may be online and transmit constant heartbeats and the station has not sent any error messages, but there may still be a problem with the EV charging station preventing users from charging at the station. In such a case, the trained machine learning model 305 may be used in the following fashion. System can enter basic information of the location of the EV charging station 401 to the trained machine learning model 305. The trained machine learning model 305 may then fetch additional information 302 automatically from public sources based on the coordinates. The additional information may comprise, for example, weather data, nearby POI locations like shops, restaurants etc. The system may the enter the usage history of the EV charging station 401 and messages the station has sent or received to the trained machine learning model 305. The machine learning model then assess what is a normal usage of the station. Then the model can check on regular basis (configurable, for example once an hour) the current usage, and alerts if the current usage differs from the typical usage. Based on the alert, the state of the charging station can be assessed.

Alternatively or additionally, once the machine learning model 305 has been trained, it can be used to, for example, notice errors on individual charging events. For example, the energy meter of an EV charging station 401 might be broken and even if charging functioned properly. Thus, the station could report abnormally high energy usage. In such a case, the trained machine learning model 305 can learn what is a normal charging event on a station, and alert of charging events which clearly differ from the normal cases. Thus, the detection of such abnormal charging events does not need to rely on predetermined parameters like energy usage. Instead, the trained machine learning model 305 can learn, based on a combination of different parameters, what is normal. In such a case, the trained machine learning model 305 could be used in the following fashion. The system can enter basic information of the location of the EV charging station 401 to the machine learning model. The system may also enter the usage history of the station and the messages the station has sent or received to the trained machine learning model 305. The trained machine learning model 305 can then assess what is a normal usage of the station, based on many different parameters, such as what is normal on a certain time of day, on a certain weekday, for a certain customer, for a certain location etc. Whenever there is a new charging event, it can be fed to the trained machine learning model 305, and the model can then alert if the charging event does not seem normal.

Alternatively or additionally, once the machine learning model has been trained, it can be used to, for example, predict different errors before they occur. For example, the model could alert that there is a high probability that a quick charger at the city centre will be broken within the next 4 weeks, and it could be beneficial to do a maintenance check on it. In such a case, the trained machine learning model 305 can be used to predict errors before they occur. Thus, the prediction does not need to rely on predetermined parameters, such as energy usage, but the machine learning model can learn, based on a combination of different parameters what are the conditions that can result in a problem with an EV charging station 401. In such a case, the trained machine learning model 305 could be used in the following fashion. The system can enter basic information of the location of the charging station into the trained machine learning model 305. The trained machine learning model 305 can then fetch additional information 302 automatically from public sources based on the coordinates. The system can also enter the details of previous error situations. The goal may be to train the model to learn when different parameters had certain values in the past, it resulted in a broken EV charging station. Once the machine learning model is trained, the system can on a regular basis (configurable, for example once a day) check what are the most likely problems that can happen in the future and can create an alert of those.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method, comprising:
obtaining a training data set from an electric vehicle, EV, charging network comprising a plurality of EV charging stations;
training a machine learning model with the training data set;
obtaining an input data set from the EV charging network;
inputting the input data set into the trained machine learning model;
obtaining an output data set from the trained machine learning model; and
identifying a malfunction of at least one EV charging station in the plurality of EV charging stations based on the output data set;
wherein the training data set and/or the input data set further comprises additional information from at least one resource outside the EV charging network and an external resource information related to a location of at least one EV charging station in the plurality of EV charging stations.

2. The method according to claim 1, further comprising:
obtaining a validation data set from the EV charging network; and
validating the trained machine learning model using the validation data set.

3. The method according to claim 2, wherein the validation data set further comprises additional information from at least one resource outside the EV charging network.

4. The method according to claim 1, wherein the output data set comprises at least one of:
indication of a subset of the plurality of EV charging stations; or
indication of at least one charging event.

5. The method according to claim 1, wherein the training data set and/or the input data set comprises at least one of:
a usage history of at least one EV charging station in the plurality of EV charging stations;
a location of at least one EV charging station in the plurality of EV charging stations;
a type of at least one EV charging station in the plurality of EV charging stations;
an error history of at least one EV charging station in the plurality of EV charging stations; or
a weather information at a location of at least one EV charging station in the plurality of EV charging stations.

6. The method according to claim 1, wherein the machine learning model comprises at least one of:
linear regression;
decision forest regression;
boosted decision tree regression;
fast forest quantile regression;
neural network; or
Poisson regression.

7. The method according to claim 1, further comprising at least one of, before the training the machine learning model with the training data set:
performing feature extraction on the training data set;
performing feature transformation on the training data set; or
performing feature scaling on the training data set.

8. A computer program product comprising program code, wherein the program code is configured to perform the method according to claim 1, when the computer program product is executed on a computer.

9. A computing device, configured to:
obtain a training data set from an electric vehicle, EV, charging network comprising a plurality of EV charging stations;
train a machine learning model with the training data set;
obtain an input data set from the EV charging network;
input the input data set into the trained machine learning model;
obtain an output data set from the trained machine learning model; and
identify a malfunction of at least one EV charging station in the plurality of EV charging stations based on the output data set;
wherein the training data set and/or the input data set further comprises additional information from at least one resource outside the EV charging network and an external resource information related to a location of at least one EV charging station in the plurality of EV charging stations.

10. The computing device according to claim 9, further configured to:
obtain a validation data set from the EV charging network; and
validate the trained machine learning model using the validation data set.

11. The computing device according to claim 10, wherein the validation data set further comprises additional information from at least one resource outside the EV charging network.

12. The computing device according to claim 9, wherein the output data set comprises at least one of:
indication of a subset of the plurality of EV charging stations; or
indication of at least one charging event.

13. The computing device according to claim 9, wherein the training data set and/or the input data set comprises at least one of:
a usage history of at least one EV charging station in the plurality of EV charging stations;
a location of at least one EV charging station in the plurality of EV charging stations;
a type of at least one EV charging station in the plurality of EV charging stations;
an error history of at least one EV charging station in the plurality of EV charging stations; or
a weather information at a location of at least one EV charging station in the plurality of EV charging stations.

14. The computing device according to claim 9, wherein the machine learning model comprises at least one of:
linear regression;
decision forest regression;
boosted decision tree regression;
fast forest quantile regression;
neural network; or
Poisson regression.

15. The computing device according to claim 9, further configured to perform at least one of, before training the machine learning model with the training data set:
perform feature extraction on the training data set;
perform feature transformation on the training data set; or
perform feature scaling on the training data set.
